(19) United States
(12) Patent Application Publication
(10) Pub. No.: US 2009/0112935 A1
(43) Pub. Date: Apr. 30, 2009

(54) INTEGRATING ACTIVITY LOG INFORMATION WITH USER-SPECIFIED CONTENT

(76) Inventor: Bradly D. Hefta-Gaub, Seattle, WA (US)

Correspondence Address: BOSWELL INTELLECTUAL PROPERTY LAW PLLC, PO BOX 1950, SEATTLE, WA, 98111, US

(21) Appl. No.: 12/260,981

(22) Filed: Oct. 29, 2008

Related U.S. Application Data
(60) Provisional application No. 60/983,472, filed on Oct. 29, 2007.

(51) Int. Cl. G06F 17/30

(52) U.S. Cl. 707/200; 707/E17.005

(57) ABSTRACT

A user content generation system is described herein that enables content authors to generate content that includes stored information from an activity log or other stored information repository. The content includes one or more references to the activity log information. When the system receives a request to display the content, the system retrieves the content including the references. The system retrieves target information of each reference from the activity log. The system renders the content including the retrieved target information in a form for display to a client application. The system sends the rendered content in response to the request. If the content author later modifies the information in the activity log, then the next time the system receives a request to display the content, the system will provide the content with the updated information.

### CROSS-REFERENCE TO RELATED APPLICATIONS

The present application claims priority to U.S. Provisional Patent Application No. 60/983,472 entitled “INTEGRATING ACTIVITY LOG INFORMATION WITH USER-SPECIFIED CONTENT,” and filed on Oct. 29, 2007, which is hereby incorporated by reference.

### BACKGROUND

There are numerous types of activities for which people track occurrences of specific events. People often track such activities in the form of a paper logbook that has a separate log entry for each event occurrence. For example, athletes may track each occurrence of a training activity (e.g., each training run), people involved in medical treatment may track each occurrence of taking particular medication or experiencing a particular symptom, and so on. More recently, such tracked activity log information may be stored in electronic form, such as in a text file or in a database. For example, personal information management (PIM) applications allow users to store various types of information electronically.

However, it is typically difficult for people to add and maintain log entries in such form, as well as to extract, analyze, and use the stored log entry information. A user may have to use a specialized application to view the information, and the application may provide limited access to the information. For example, an email application with a journal or note-taking feature may not make entries available when the user is not running the email application. The email application may also store the information on the user's local computers, so that the user does not have any access to the information when the user is away, such as while at work or traveling, without taking extra steps to copy the information in a portable format (e.g., copying a data file to a USB drive).

Blogging is becoming a common way for content authors to share their experiences with other people. Blogs often include posts about a subject area in which a content author has expertise, about events the content author has experienced, or about other topics of interest to the content author. For example, a content author interested in physical fitness may create blog posts describing the details of the content author's workouts or about the user's progress toward meeting a goal relating to his/her body. A blog is generally accessible via the Internet and users can view the blog on a device with a web browsing application. Blogs are easy to create and thus make it easy for any user to become a content author.

Unfortunately, blogs are also difficult to maintain and may include posts with out of date or incorrect information. A user generally adds blog posts serially over time, and rarely returns to earlier blog posts to verify their content or update the posts with new information. In addition, maintaining a blog is time consuming as popular blogs keep the attention of readers by constantly adding new blog posts and content.

### BRIEF DESCRIPTION OF THE DRAWINGS

FIG. 1 is a block diagram that illustrates components of the user content generation system, in one embodiment.

FIG. 2 is a flow diagram that illustrates processing of the compose component of the user content generation system, in one embodiment.

FIG. 3 is a flow diagram that illustrates processing of the rendering component of the user content generation system, in one embodiment.

FIG. 4 is a display diagram that illustrates a display page of the user content generation system for content authors to create content, in one embodiment.

FIG. 5 is a display diagram that illustrates a display page of the user content generation system for rendering dynamic content to users, in one embodiment.

### DETAILED DESCRIPTION

A user content generation system is described herein that enables content authors to generate content that includes stored information from an activity log or other stored information repository. For example, the system may enable a blog author to include information from an activity log. In some embodiments, the content includes a reference to the activity log information and the system dynamically updates the content by retrieving the reference when the system receives a request to display the content. A content author creates new content in an editor. For example, the content author may create content in a text editing application. As the author creates new content, the author places one or more references in the content that refer to a particular activity log entry and one or more fields of the entry. The system receives the new content from the author and stores the content in a data store for display to other users. When the system receives a request to display the content, the system retrieves the content including the references. The system retrieves target information of each reference from the activity log. The system renders the content including the retrieved target information in a form for display to a client application. The system sends the rendered content in response to the request. If the content author later modifies the information in the activity log, then the next time the system receives a request to display the content, the system will provide the updated information. Thus, the system makes the content author's entries in the activity log more useful and accessible and makes it easier for content authors to include up to date and correct information in a blog or other content display.

In some embodiments, the user content generation system provides a user interface that enables a user to generate user content (e.g., content that will be provided to or otherwise made available to other users), and further to specify one or more associated entries from one or more activity logs or other stored information repositories. When the system displays or otherwise provides the generated user content to one or more users, information from one or more of the associated entries is displayed together with the user content. For example, the system may dynamically retrieve current information from the one or more associated entries at the time of display or other provision of the information to the users. As discussed in further detail herein, such techniques may provide a variety of benefits in a various situations, such as to enable an athlete to maintain a training log book and to integrate information about particular training occurrences with other content generated by the user, and then to make that generated content and integrated training occurrence information available to other users.

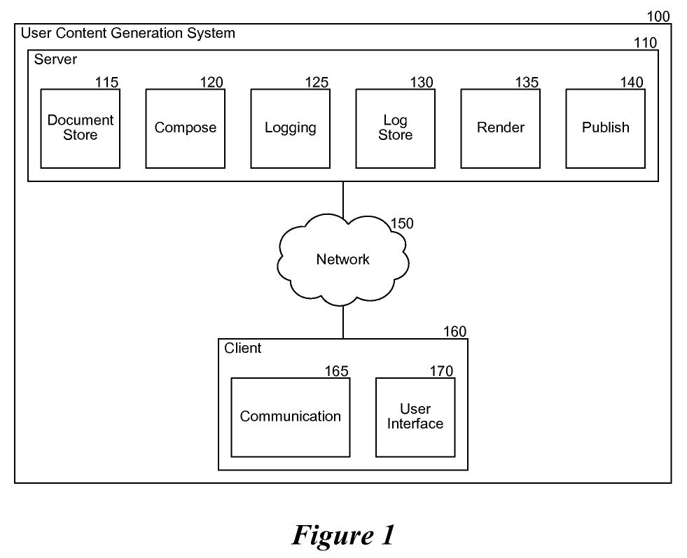

FIG. 1 is a block diagram that illustrates components of the user content generation system, in one embodiment. The system 100 includes a server 110 that is suitable for automatically performing at least some of the described techniques, such as by executing software implementing at least some components of the system 100. The server 110 includes a document storage component 115, a compose component 120, a logging component 125, a log store component 130, a render component 135, and a publish component 140. The server 110 is connected to one or more client devices 160 via a network 150 (e.g., the Internet or a cellular telephone network). At least some of the client devices 160 include a communication component 165 and a user interface component 170. Although a server 110 and client 160 are shown for illustration, those of ordinary skill in the art will appreciate that the system may operate in numerous other configurations. For example, all of the components may operate locally on a single computer system or some or all of the components may be hosted by a web-based application hosting service.

The user interface component 170 may be part of an application (e.g., a Web browser) on the client device 160 that interacts with the server 110 through the communication component 165 (e.g., a TCP/IP stack) to request at least a portion of the a user interface that allows a user of the client device 170 to request user-generated content to display. Upon receiving the requested content (e.g., via one or more Web pages), the user interface component 170 displays the content to the user with a display device (not shown). The user interface component 170 may then receive additional requests from the user to specify user-generated content and/or specify logbook entries that the user wants to view. The communication component 165 communicates with the server 110 to obtain the additional information and when the client 160 receives the information, the user interface component 170 updates the display with the new information.

Both content authors and viewing users may access the system 100 through client devices, such as client device 160. For example, the content author may use a client device, such as client device 160 to compose new user-generated content. The server 110 may provide display information for displaying a content composition web page that the user interface component 170 displays on the display. When the content author is finished composing user-generated content and/or logbook entry data using the content composition web page, the communication component 165 sends the results to the server 110 over the network 150. Similarly, viewing users may receive a rendering of the content through a client device, such as client device 160.

The compose component 120 receives content and/or logbook entries from the content author. The compose component 120 may provide an editing user interface through which the content author can create new content. The content author may enter logbook entries and then compose content that integrates references to the logbook entries in the editing user interface. Alternatively, the content author may compose content containing the logbook information and identify the fields containing logbook information. The system 100 may then automatically identify the logbook entries. When the user is finished editing through the editing user interface, the system 100 saves the information. The system 100 stores content created manually by content authors and/or automatically by the system 100 in the document store component 115 and logbook entries in the log store component 130. The document store component 115 and log store component 130 may include a database, XML file, or other storage system for persisting content information over time. In some embodiments, the document store component 115 and log store component 130 may be the same data store. The log store component 130 may perform processing of the data before or after the storage (e.g., to aggregate information from multiple logbook entries).

When a user requests information from the system 100 (e.g., via client device 160) that includes user-generated content, the communication component 165 of the client device 160 sends a request over the network 150 to the server 110 to obtain the information. The render component 135 receives the request and retrieves the requested content from the document store component 115 and any referenced log entry data from the log store component 130. The logging component 125 loads the requested log entry data from the log store component 130 and returns it to the render component 135. The render component 135 integrates the returned log entry data with the retrieved user-generated content. For example, the render component 135 may replace specified field codes in the user-generated content with values from corresponding attributes of the returned log entry data. The render component sends the integrated information to the publishing component 140, which sends the information over the network 150 to the client device 160 for display to the requesting user.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on. In addition, although a log store or database are discussed singularly for ease of explanation, those of ordinary skill in the art will appreciate that a store or database can be stored on many servers, such as for scalability, ease of data analysis, fault tolerance, and so forth. For example, in a multi-server implementation users of the described system may be partitioned so that all of the data for a particular user is available on a single server to reduce the cross-server overhead of responding to requests for that user.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

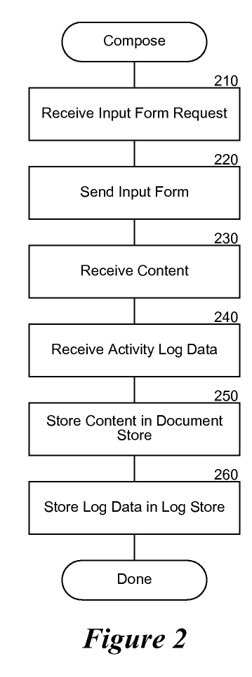

FIG. 2 is a flow diagram that illustrates processing of the compose component of the user content generation system, in one embodiment. The system invokes the component when the system receives a request from a content author to compose new content. In block 210, the component receives a request for an input form for inputting new content. For example, a client application may request a user interface from the user content generation system, such as a user-modifiable input form. The form may include an HTML form or other suitable interface in which the user can enter and layout content that the user wants to publish. In block 220, the component sends the input form in response to the request. The client application then receives information specified by the user, such as one or more logbook entries and user-generated content (which optionally may include one or more field codes corresponding to that or other logbook entry data). After completion, the client application component sends the user-specified information the user content generation system. In block 230, the component receives the content entered by the user. For example, the content may include a blog post with references or other placeholders that the system will fill in with log entry data when the system renders the blog post.

In block 240, the component receives activity log data. The user may enter logbook data at the same time as creating content that references logbook data, or at a different time. The user may also use a separate application or user interface for entering logbook data than for creating content that references the logbook data. For example, the user may enter logbook data using a PIM or other activity-based application, while the user may use a word processing application for creating content that references the logbook data. The system may provide these applications or user interface via the input form or they may be separate stand-alone applications for which the system has access to stored data. In block 250, the component stores received content in the document store. For example, the system may create a new row in a database table that contains the content and other metadata related to the content (e.g., the time the system received the content, the user that created the content, and so forth). In block 260, the component stores received log data in the log store. For example, the component may create an XML entry or database table row describing each entry received. After block 260, these steps conclude.

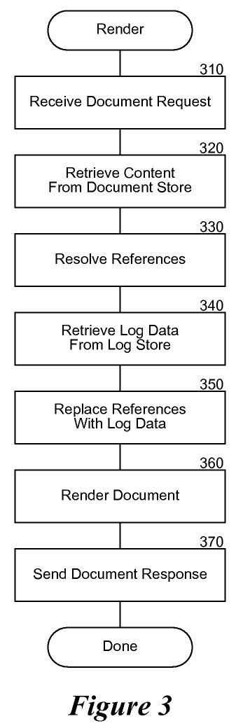

FIG. 3 is a flow diagram that illustrates processing of the rendering component of the user content generation system, in one embodiment. The system invokes the component when the system receives a request to display content managed by the system, such as a document. In block 310, the component receives a request for a document. For example, the system may provide some or all of the pages of a website, and at least one web page may contain one or more blog posts that represent documents stored by the system. In block 320, the component retrieves content related to the requested document from the document store. For example, the content may include the content stored with reference to FIG. 2 after a content author creates a new document. The content includes one or more references to activity log data. In block 330, the component resolves any references in the retrieved content to determine which activity log entries are relevant for the system to display the content. For example, the content may reference the latest running entry in a running training log.

In block 340, the component retrieves the relevant log entries from the log store. For example, the component may retrieve the entries from a database or other log entry data store. In block 350, the component replaces references in the retrieved content with information from the retrieved log entries. For example, the component may search for field codes in the content and replace each identified field code with appropriate log entry data. In block 360, the component renders the document in a format suitable for the requester. For example, if the requester is a web browser (e.g., as indicated by the received request), then the component may render the document using HTML. In block 370, the component sends the rendered document in response to the received request. For example, the component may send the rendered document over the Internet or another network to a client requester. After block 370, these steps conclude.

The described techniques may be used with a variety of types of user-generated content and for a variety of purposes. For example, in some embodiments, the user-generated content may include blog comments or other types of information about the user, such as for display on a user's personal blog or other Web site, on a Web portal or other site specific to one or more topics or areas of interest, on a social networking site (e.g., as part of a profile page or other personal space for the user), and so forth.

In addition, the described techniques may be used with a variety of types of activity log information or other types of stored information with multiple entries that share common characteristics. For example, a particular activity log may in some embodiments be stored in a database, with each log entry represented by one or more rows in one or more relational database tables, or may instead be stored in other forms (e.g., as part of a calendar or diary). A particular activity log may support one or more types of entries, with each entry of a particular type sharing common attributes. For example, an athlete user who is having running training sessions may create a separate entry for each training session that includes values for some or all of a group of attributes such as time-of-day, day-of-week, day-of-year, distance covered during activity, length of time of activity, weather conditions, heart rate, amount of weight being carried, and so on. The system may also store data received in multiple different formats into a canonical common form. For example, data received from a heart rate monitor may include heart rate and time, whereas data received from a GPS device may include location and time. The system maps the available fields of data from the device or other information source to fields that can be rendered by the system and stores the data in a common format regardless of the original source.

In some embodiments, the user content generation system selects among several output formats for rendering the content and logbook data. The system takes the logbook data and the user content and makes the best choice based on the requested output format as to how to render it. For example, the system may render the content as a full blog post, summary blog post, article teaser (e.g., a lead in paragraph of a blog post including logbook data, such as for a home page), limited character output format (e.g. suitable for posting on Twitter, Pownce, via Short Message Service (SMS) to a cell phone, or other short text information services), Facebook/Friendfeed “Activity Streams,” and so forth. The system may also render the data in different formats to aggregate data into different view or allow a user to analyze the data in different ways. For example, the system may render the data in a calendar view, chart view, table view, and so on in addition to simple or formatted text. Thus, the system can take the same semantic data (the logbook entry and the user content) and blend them appropriately for the desired output format.

In addition, in some embodiments the system converts data stored in the common format described above at render time based on factors such as preferences expressed in field codes, a type associated with the document in which the system will include the data, and profile or other information about the user viewing the data. For example, the system may receive data in a variety of units, such as minutes per mile for running, miles per hour for biking, and time per hundred meters for swimming. The system converts the data and stores the data as, for example, feet per second, for each of these types of data. At rendering time, a content author writing an article about swimming may expect to see swimming log data in time per hundred meters, and the author may request these units from the system by placing format information into the field codes, by specifying a type of the article as “swimming,” and so forth. Alternatively or additionally, the system may select the output format of the data based on information about the user viewing the content. For example, if the logbook data represents information about global financial transactions in a stock market, and an article relates to economic news about those transactions, users in Japan may want to view the article with financial figures in Yen, while users in the U.S. may want to view the article in Dollars. Thus, the system may select an appropriate output format for the logbook data base on preference information specified by the viewing user.

In some embodiments, the user content generation system may receive information for activity log entries through varying transports. The system may receive the same information directly from the user, through another separate activity logging system with which the user content generation system communicates, and/or from multiple types of these sources. For example, the user may manually specify some or all of the values, or one or more devices of the user that track the information (e.g., as initiated by the user) may automatically supply the information. The devices may include, for example, a pedometer, GPS device, heart rate monitor (e.g., a monitoring watch), or other devices. The system may also receive information from other websites, such as through Really Simple Syndication (RSS), Twitter, or other protocols and services. In addition, the same athlete user may also track other activity log entries corresponding to other types of activities, which may have at least some attributes that differ from the attributes of the running training entries. For example, the user may track cycling training sessions using additional attributes such as revolutions-per-minute, but not using an attribute corresponding to an amount of weight the user is carrying.

In one example, a user may wear a device that uploads information to the Internet (e.g., the Nike Plus shoe, or Apple iPhone applications). The system may receive information, such as where and how fast a user walked, directly from the device, through a web service hosted by the manufacturer of the device, manually from the user, and so forth. When the information is stored in a system separate from the user content generation system, the user content generation system may request login information for the separate system from the user and extract the information from the separate system using web scraping and/or other well-known data extraction techniques. Regardless of the transport through which the system receives the information, the system places the data into the log store in a common format as described herein.

In some embodiments, the content author associates content with activity log entries. A content author may associate one or more activity log entries with a particular piece of content in various ways. For example, the content author may indicate one or more particular activity logs with which the content is associated, one or more particular types of log entries of those activity logs with which the content is associated, and/or one or more particular log entries with which the content is associated. Alternatively or additionally, if the system is maintaining a single activity log with a single type of log entry for a particular content author, the system may automatically associate that activity log and log entry type with the content.

In addition, the system may associate one or more particular log entries with a piece of user content. In some embodiments, the user may designate a particular log entry and the system may retrieve some or all of the information from the designated log entry. For example, the user may designate a log entry by the time associated with the log entry or by a unique log entry identifier for the log entry. The system may include the information with other user content, such as at the time of designating the log entry and/or at a later time of displaying or otherwise presenting or providing the user content (whether to the content author and/or to one or more other users).

Furthermore, in some embodiments, a user may designate one or more particular attributes corresponding to one or more types of activity log entries, such that the system obtains information for the designated attributes from one or more log entries and includes the information with the other user content. For example, a user may designate a particular log entry and a particular attribute, such that the system obtains a stored value for that attribute and log entry when the system prepares the content for display. Alternatively or additionally, a user may designate one or more log entry attributes without designating a particular log entry and if so the system may dynamically select one or more log entries so that the system obtains stored values for those attributes and selected log entries when the system prepares the content for display. As one example, the system can select the most recent log entry, whether at the time of the generation of the user content or the most recent log entry later when the system prepares the user content for display.

In some embodiments, the user content generation system enables a content author to reuse a particular piece of user-generated content. This may be of particular benefit when the system dynamically selects one or more activity log entries at a time of display or other provision of the user content. For example, a runner could include information indicating that “my most recent run was for <distance> miles,” with the <distance> field corresponding to a most recent corresponding log entry for a corresponding distance attribute. When the content is displayed, the system dynamically determines the most recent entry satisfying the reference in the content, and replaces the reference with the appropriate information. Additional details are included herein related to the designation of log entries and attributes, and those of ordinary skill in the art will appreciate many common ways that one or more log entries can be identified dynamically (e.g., by satisfying one or more user-specified constraints, such as based on values for one or more attributes of the entries).

In addition, in embodiments in which a piece of content includes one or more fields to be replaced with one or more corresponding attributes' values from an activity log entry, a particular user may further specify multiple different pieces of content that each specify the same or similar fields and corresponding attributes. If so, the system may in some embodiments allow the user to designate the multiple content pieces as alternatives such that different ones of the alternatives will be selected at different times for use in displaying or otherwise providing information. For example, such alternative content pieces may include multiple different phrasings, with a particular content piece to be used at a particular time being chosen randomly. For example, to describe a running training session, a non-exclusive list of alternative content pieces is as follows: 1) “I ran <distance> miles today in <time-duration>, for an average pace of <pace>,” 2) “Run training: <distance> miles at <pace>pace, <time-duration> total time,” 3) “Running—<time-duration> hours—<distance> miles—<pace> pace—<comments>.” In addition, in some embodiments the system may further provide predefined content pieces that a user may select and use as one or more alternative content pieces. Furthermore, in some embodiments the system may facilitate sharing of content pieces between some or all users, such as to allow an author user who generates a content piece to specify whether, how, and which other users may use the content piece.

As previously noted, the described techniques may be used with a variety of types of logged or otherwise tracked information, whether stored in activity logbooks or other forms. For example, in addition to use with fitness training logging entries, a non-exclusive list of other types of tracked information includes medical records, health checkups, rally car driving, drag racing, stock car racing, gymnastics competition, scuba logs, weight training, diet logs, scientific log, research logs, calendar entries, and so on.

In addition, in some embodiments the user content generation system may allow users to specify a variety of types of additional information regarding content pieces, such as to allow the user to control how the content piece information is displayed or otherwise presented. Such types of additional information may include types of formatting similar to that found in word processing or content publishing systems, such as to control fonts, typefaces, colors, sizes, highlighting, bolding, italics, positioning, and so forth. Furthermore, the users who use the system may be of various types in various embodiments, including professional writers, professional athletes, casual or amateur users, and so on.

Furthermore, in some embodiments, the user content generation system may provide a user interface that allows a user to add and/or modify log entries in a manner that is integrated with a user interface that allows a user to generate (e.g., create and/or modify) content pieces with fields corresponding to attributes of those log entries. For example, the system may provide a single user interface that has different sections or areas to enable a user to both interact with log entries and interact with content pieces. FIGS. 1 and 2 provide illustrative examples of one particular interface embodiment with which at least some of the described techniques may be used, as discussed below. Furthermore, in at least some embodiments, the system may be provided via a server (e.g., as a Web server or otherwise over the Internet or other network), such that multiple users may access and use the system from remote client devices (e.g., client computer systems executing Web browsers or other specialized client-side software)—if so, the system may store some or all of the users' data on the server, so as to allow a user to interact with the system from any client device and be able to access and modify previously stored data.

For illustrative purposes, some embodiments are described in which various types of user-supplied information is tracked, stored, generated, and provided to users in various ways. These examples are provided for illustrative purposes and are simplified for the sake of brevity, and the system may be used in a wide variety of other situations, some of which are discussed below.

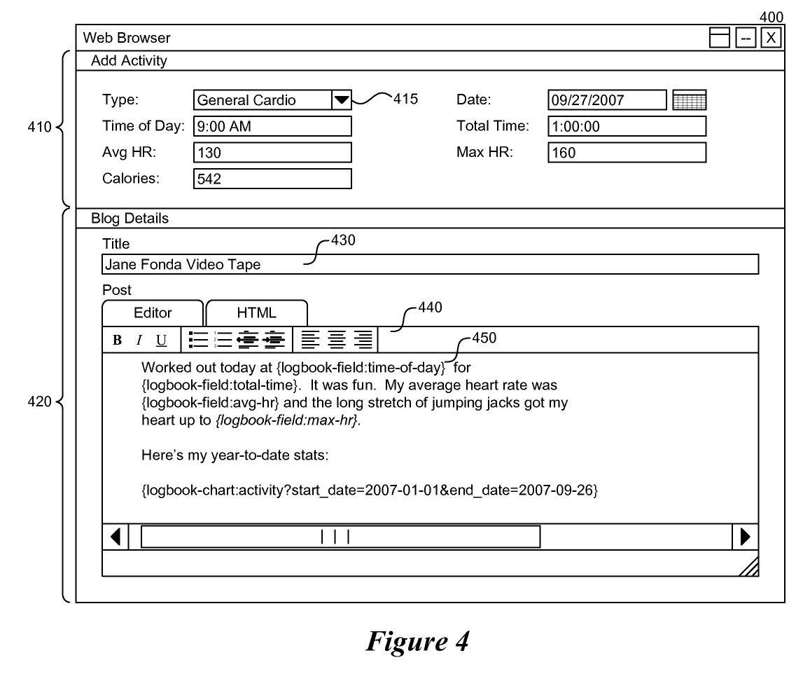

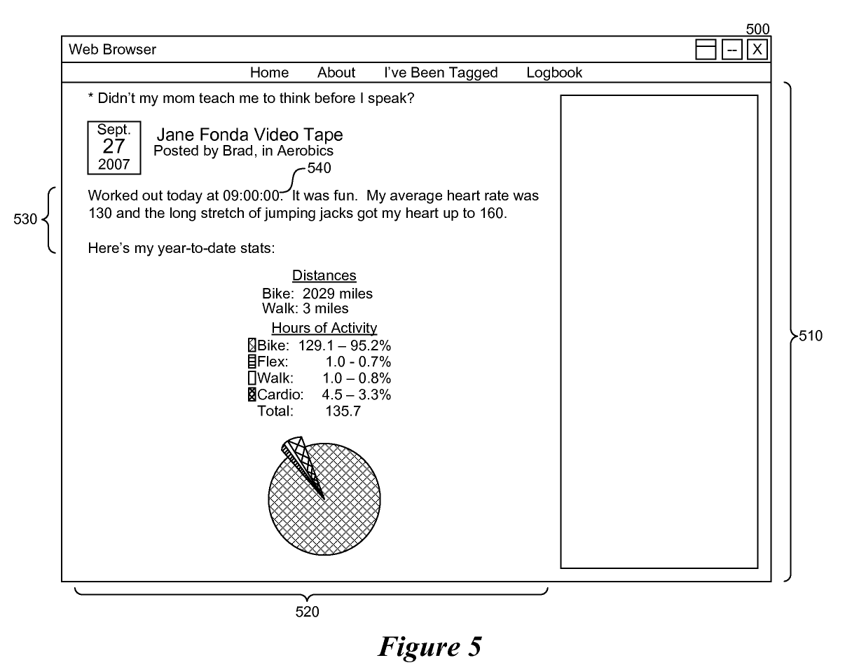

FIGS. 4 and 5 illustrate examples of integrating activity log information with other user-generated content via an example graphical user interface. In these examples, an embodiment of the user content generation system provides functionality that integrates aspects of a publishing platform and of a logbook record keeping system, such that the publishing platform controls the rendering of both publishing platform content and logbook record content. The system allows information from log book entry attributes to be incorporated in written reports or other user-generated content with rich formatting capabilities based on using field codes (also referred to as fields) within the user-generated content. A field code may be a reference to one or more particular attributes of a logbook or other type of tracked information, such as based on an attribute name used within the logbook entry. For example, the system may create a particular field code that is a specified grouping of multiple other field codes, so that content may reference the grouping by a single name. Such field codes may represent single values, text fragments, or objects like charts and tables.

FIG. 4 is a display diagram that illustrates a display page of the user content generation system for content authors to create content, in one embodiment. In the illustrated embodiment of FIG. 4, the publishing platform is based at least in part on a blogging platform (e.g., the WordPress blogging platform, such as using a plug-in), and the provided activity log corresponds to fitness activities. The display page 400 includes an add activity area 410 and a blog post creation area 420. In the add activity area 410, the content author is able to choose an activity type 415 to log (e.g., cycling, running, swimming, and so forth.), enter data about particular occurrences of that activity type 415 via form fields of the user interface, and specify particular attributes of that activity type 415 (e.g., time, pace, heart rate, and so on) to be incorporated into a blog post about the activity. In the blog post creation area 420, the content author can provide a title 430 for the blog post and a body 440 for the blog post. The body 440 may include field codes that incorporate data from the activity log dynamically in the blog post.

In some embodiments, the system will apply any formatting the content author applies to the field code in the blog post (e.g., bold, italic, underline, font typeface, font size, and so forth) to the field data at rendering time. Furthermore, the content author may be able to specify particular field codes within a blog posting or other piece of user-generated content in various ways, such as by manually typing the field code, selecting the field code from the add activity area 410 or other part of the user interface (e.g., via drag-and-drop).

As one example, a user could enter the following HTML blog post: “Went for a {logbook-field: distance} run this morning. My average heart rate was {logbook-field: avg-hr}, which is really good for the <b> {logbook-field: avg-pace} </b> pace I was running.” The text “{logbook-field: distance}” is an example of an embedded field code or reference. In this embodiment, the system stores the field codes with the blog post, and replaces the field codes at rendering time with values from a selected logbook entry. If a content author later updates the selected logbook entry with more information or corrections, the system displays the blog post correctly with the corrections or additions the next time a user requests the blog post for viewing. Based on a particular logbook entry, the system may render the above example blog post as follows: “Went for a 5.7 mile run this morning. My average heart rate was 146 which is really good for the 7:15 pace I was running.”

FIG. 5 is a display diagram that illustrates a display page of the user content generation system for rendering dynamic content to users, in one embodiment. The display page 500 includes a web page 510 with at least one blog post 520. The blog post 520 contains body text 530, that includes at least one element 540 provided by the system dynamically based on log entry data. The system replaces field codes in the original blog post with values of attributes of a corresponding log entry, and/or summary information gathered from multiple log entries. After the content author has created the example blog post illustrated in FIG. 4, the system may display that blog post to the content author and/or other users.

While particular types of information and information manipulation have been illustrated with respect to FIGS. 4 and 5 to provide illustrative examples of information and functionality corresponding to at least some of the described techniques, it will be appreciated that other types of information and functionality may alternatively be used in other embodiments.

Furthermore, particular embodiments of the user content generation system may provide various types of functionality. As one example, a particular embodiment of the system may provide training logbook functionality to allow various users to store, track, and use information about their training activities. The training log may be a frequently used feature for active users, such that many such users may interact with the training log of the system every day. The training log may further be designed and provided to allow users to record detailed data for each training occurrence or event if so desired, or to allow other users to specify more limited data if so desired.

In some embodiments, activities are the basic unit of storing exercise data. For example, a “workout” is typically considered a single activity occurrence. However, in order to support multi-part and multi-sport workouts, the actual detailed data for an activity may be stored in one or more activity segments. Segments have a particular type, such as running, cycling, swimming, strength training, and so on. While a particular activity may have only one segment, it is also possible for a single activity to have multiple segments (e.g., for a particular workout to have multiple different segment types). In this embodiment, all segments support the following common attributes: “duration,” “active duration,” “average and max heart rate,” “calories, “comments,” “description,” and “heart rate” sampling data. In addition, various particular segment types may support other attributes, as follows.

In addition to the common attributes, cycling segments support: “distance,” average and max cadence, average and max speed, average and max power, ascent and descent, equipment that was used, course, laps, and intervals. Using support for data sampling, segments may also be able to store instantaneous (or sampled) data for roll-up attributes such as: heart rate, speed, cadence, power, and location.

In addition to the common attributes, running segments support: “distance,” average and max pace/speed, ascent and descent, equipment that was used, course, laps, and intervals. Using support for data sampling, segments may also be able to store instantaneous (or sampled) data for roll-up attributes such as: heart rate, speed, and location.

In addition to the common attributes, swimming segments support: “distance,” “stroke,” equipment that was used, laps, and intervals. Using support for data sampling, segments may also be able to store instantaneous (or sampled) data for roll-up attributes such as: heart rate.

In addition to the common attributes, strength training segments support: repetitions, weight, equipment, tempo, and a reference to an exercise type. Strength training is an example of a type of segment in which some users will want to store more detail and others will want to store less detail (e.g., simply want to record a time and effort). For example, in a more detailed form, users may store multiple exercises (e.g. “bicep dumbbell curls”) with multiple sets of different repetitions and weights.

Flexibility segments are similar to strength training segments in that they may include specific flexibility exercises that a particular user wants to record as completing during a particular routine, while other users may merely use a generic time-based segment indicating that some flexibility work was done for a particular duration. Rest segments are off-days that are part of a user's training program, such as for use by advanced athletes who specifically schedule such rest segments.

As previously noted, particular activity occurrences may include one or more segments. Multiple segments are useful for, for example, storing laps, or intervals, or in the case of strength training, multiple reps within a set and multiple sets within a workout. In addition, the use of multiple segments allows a single activity occurrence to include multiple sports/exercise types, such as may be of use in storing training activities for triathlons or for interval-style workouts. Multisport activities like “Brick” workouts may be structured to contain a single activity “header” and multiple segments, each of which may be of a different type. For example, a typical bike/run brick workout may be represented as a single activity occurrence with two segments, with one of type bike and one of type run. A brick workout that includes laps or intervals may include data stored in multiple segments, but may further support a rollup of the laps or intervals into a single set or other aggregation.

Various information may be tracked and used for users of the system, such as may be specified and modified by the users. Some attributes of a user may change rarely or never, such as name, birth date, gender, contact information, an avatar, height, and so on. A variety of other types of information may additionally be stored, such as maximum heart rate (or “HR”), upper and lower threshold HR, one or more HR zones, sports of interest, access rights to data (e.g., a list of other users or groups with specified access, such as to allow a coach to add workout goals and to allow other specified users to view a workout plan), particular equipment items used, and so forth. In addition, some fitness status user information may be stored for some or all users (e.g., weight, resting HR, blood pressure, and so on), such as to be recorded with a date parameter on a daily or other regular basis and tracked over time.

The various stored user-related information may be used in various ways, such as preference information (e.g., to display to a user information only about sports of interest). Other preference information may include data such as units of measure (e.g., miles versus kilometers or Fahrenheit versus Celsius) that they would like displayed by default. In addition, users may be able to customize the user interface in various ways, such as to change the display options for a sport in their UI (e.g., color, icon, name, abbreviation), to change attributes used for a sport, to add a new sport that is not among the predefined sports (and specify appropriate noncommon attributes, such as a name, abbreviation, unit, HR zone, and so on for each attribute), and so on. Furthermore, users may be able to add “goals” and “future plans” to their calendar, such as races, training periods, intended workout/workout plans, goal hours, goal miles for various disciplines, and so forth. In addition, users may be able to specify courses (e.g., via name, location, and optional association to one or more segments), such as to record personal best times for various common workouts.

The system may also track groups of users, such as to support teams or leagues of athletes who want to be organized to allow additional tracking of their collective performances. A user can be part of multiple groups. Groups may have the following attributes: a name, a location, a list of users who are members, a list of users who are leaders (e.g., and have special privileges within the group), specification as to whether or not the group is “open” and can be joined by anyone or instead is “closed” and only modifiable by an administrator of the group, and so forth.

Users may also be able to specify one or more blogs or other information sources external to the system, such as their own separate personal blogs, so that information from that external information source may be obtained and integrated with the system (e.g., via RSS or a mirrored mini-blog).

The user content generation system may provide various community forums that are editorially managed and a collection of topics on a particular general area of discussion (e.g., “gear,” “training tips,” “running,” “gyms,” and “nutrition”). For example, each topic may be a separate conversational thread within a forum, with each post within a topic being a comment.

While particular types of information and information manipulation have been discussed with respect to particular embodiments of the system, it will be appreciated that other embodiments of the system may have other functionality, including more and/or less than that described with respect to the particular embodiments.

From the foregoing, it will be appreciated that, although specific embodiments of the user content generation system have been described herein for purposes of illustration, various modifications may be made without deviating from the spirit and scope of the invention. Accordingly, the invention is not limited by the exemplary details. In addition, while certain aspects of the invention may be now or later presented in certain claim forms, the inventors contemplate the various aspects of the invention in any available claim form. For example, while only some aspects of the invention may be initially recited as being embodied in a computer-readable medium, other aspects may likewise be so embodied.

I claim:

1. A computer-implemented method for providing updated information in user generated content, the method comprising:
receiving from a client a request for a document;
retrieving content related to the requested document from a document store, wherein the content includes one or more references to log data;
resolving the references included in the content to determine one or more activity log entries relevant for the system to display the content;
retrieving the relevant resolved log entries from a log store;
replacing references in the retrieved content with information from the retrieved log entries;
rendering the document in a format associated with the received request; and
sending the rendered document in response to the received request,
such that if a modification has been made to the resolved log entries since a last time the document was rendered, the rendered document includes the modifications.

2. The method of claim 1 wherein the requested document is a blog post wherein a body of the blog post contains fixed text and dynamically rendered text.

3. The method of claim 1 wherein replacing references comprises searching for field codes in the content and replacing each identified field code with log entry data.

4. The method of claim 1 wherein the log store is maintained by a separate system and wherein retrieving the relevant resolved log entries comprises requesting the entries from the separate system.

5. The method of claim 1 wherein at least one reference in the content specifies a most recent corresponding log entry having specified attributes.

6. The method of claim 1 wherein at least one reference in the content specifies multiple alternative log entries to be rendered in a rotation at different times.

7. The method of claim 1 wherein multiple users share log entries, and wherein at least one reference refers to a log entry for a user other than an author of the content.

8. The method of claim 1 wherein the content includes formatting information for references and wherein rendering the document comprises rendering the relevant resolved log entries according to the format information.

9. The method of claim 1 wherein rendering the content comprises selecting among multiple output formats for rendering the content and logbook data.

10. The method of claim 1 wherein the log store includes information about one or more groups of users and wherein at least one reference in the content refers to information about at least one group.

11. A computer system for integrating activity log information with user-specified content, the system comprising:
a compose component configured to receive user-specified content and logbook entries from a content author;
a document store component configured to store received user-specified content created by content authors;
a log store component configured to store received logbook entries created by content authors;
a render component configured to receive requests to render user-specified content and retrieve the requested user-specified content from the document store component and one or more referenced logbook entries from the log store component; and
a publish component configured to send rendered user-specified content in response to requests received by the render component.

12. The system of claim 11 wherein the compose component is further configured to provide an editing user interface through which the content author can create new content.

13. The system of claim 11 wherein the compose component is further configured to receive logbook entries from the content author and content that includes references to the logbook entries.

14. The system of claim 11 wherein the compose component is further configured to receive content containing logbook information within the content and wherein the compose component automatically identifies the logbook entries within the content.

15. The system of claim 11 wherein the log store component is further configured to perform processing of the received logbook entries to aggregate information from multiple logbook entries.

16. The system of claim 11 wherein the render component is further configured to replace references in the user-generated content with values from corresponding attributes of the referenced log entry data.

17. A computer-readable storage medium encoded with instructions for controlling a computer system to receive composed user-generated content that includes dynamic log entry data, by a method comprising:
receiving a request for an input form for inputting new user-generated content;
sending the input form in response to the request;
receiving the new user-generated content, wherein the new user-generated content includes at least one reference to log entry data previously specified by a user;
storing the received user-generated content in a document store; and after receiving the new user-generated content,
receiving updated log entry data to be displayed in association with the user-generated content when the system displays the user-generated content, and
storing the updated log entry data in a log store.

18. The computer-readable medium of claim 17 wherein the log entry data is received from a separate system, and further comprising converting the data from the format of the separate system into a common format for entries in the log store.

19. The computer-readable medium of claim 17 wherein the user-generated content includes a blog post with references that the system will fill in with log entry data when the system renders the blog post.

20. The computer-readable medium of claim 17 further comprising providing a different input form for receiving log entry data through which the method receives updated log entry data.
